(19) United States
(12) Patent Application Publication
(10) Pub. No.: US 2009/0080283 A1
(43) Pub. Date: Mar. 26, 2009

(54) Dynamic mixer

(75) Inventor: Roberto Cutri, Bremgarten (CH)

Correspondence Address: OLIFF & BERRIDGE, PLC, P.O. BOX 320850, ALEXANDRIA, VA, 22320-4850, US

(73) Assignee: SIKA TECHNOLOGY AG, Baar (CH)

(21) Appl. No.: 12/232,986

(22) Filed: Sep. 26, 2008

Related U.S. Application Data
(63) Continuation of application No. 11/792,675.

(30) Foreign Application Priority Data
Dec. 13, 2004 (EP) 04106512.9

(51) Int. Cl. B01F 15/02

(52) U.S. Cl. 366/133; 366/165.3; 366/134

(57) ABSTRACT

A dynamic mixer comprising a rotor, which is coupled to a drive shaft and which is rotationally mounted in a mixing chamber provided inside a rotor housing; at least one first and one second constituent can be fed to said mixing chamber; the drive shaft comprises at least one wavy channel via which the second constituent can be introduced into the mixing chamber; the mixing device is simplified since the second constituent is fed through the channel provided in the drive shaft; no separate connection for supplying the second constituent is provided on the rotor housing whereby enabling the rotor housing to have a simple design and be economically produced; the assembly and disassembly of parts are also simplified, particularly of the rotor and rotor housing, which can be disposed of or cleaned after the mixer has been used, allowing the dynamic mixer to be repeatedly reused.

### TECHNICAL FIELD

The invention is based on a device for mixing at least two free-flowing components according to the preamble of the first claim.

### PRIOR ART

Mixing devices are generally used where two or more flows of free-flowing substances or components are mixed to form a completely or partly intermixed common free-flowing substance flow. Mixing devices are used which are disposed of after use or are cleaned and used again repeatedly.

The use of mixing devices for mixing reactive components is known from the adhesives industry, said mixing devices serving both for the essentially homogenous mixing of the components of multi-component adhesives and for the layered mixing of curing accelerators into single-component adhesives.

Static mixers are known in which the mixing is effected by repeated dividing of the material strand, and dynamic mixers are known in which the processed components are repeatedly divided or even swirled by means of a moving element.

Static mixers which have no movable parts (see, e.g., WO 02/32562 A1) are especially suitable for mixing substances of low viscosity.

In particular for the mixing of highly viscous substances, therefore, dynamic mixers having a rotor are preferably used, said rotor being rotatably arranged in a mixing chamber into which the substances to be mixed are introduced. Mixing devices of this type are described, for example, in EP 0301201 A1, EP 1106243 A2, DE 10112904 A1 and EP 1106243 A2.

The devices described in these documents have a rotor housing which is provided with two material openings, serving to introduce the components to be mixed, and a drive opening, through which a drive shaft can be inserted into a recess of the rotor in a positive-locking manner.

Various problems occur in the case of the known mixing devices. For the feeding of the components to be mixed and the connection of the drive shaft, various openings and connections are to be provided on the rotor housing, for which reason correspondingly high production costs result. In particular during the mixing of reactive components, the mixing devices have to be replaced after a relatively short operating period, for which reason correspondingly high costs for the purchase and disposal of the mixing device arise for the user.

Furthermore, a relatively high expenditure of energy results for the mixing of the substances fed separately through two openings, and this high expenditure of energy leads to undesirable heating of the reactive substances.

Further undesirable heating of the mixed product is to be expected, since the rotor sitting on the drive shaft, in one-way embodiments, is held in position by the rotor housing and therefore rubs thereon during operation.

If components having different volumetric proportions are used, the known mixing devices are to be adapted accordingly, possibly with additional expenditure. To this end, in the device described in DE 10112904 A1, a deceleration chamber is provided for one of the components. Corresponding molds are required for realizing this deceleration chamber.

Furthermore, the material flow and the mixing ratio in the known mixing devices cannot be set, for which reason corresponding controllable drive devices or mixing devices configured in different ways are required.

### SUMMARY OF THE INVENTION

The object of the invention is to provide an improved dynamic mixer of the type mentioned at the beginning.

The dynamic mixer is to be of simple design, is to be capable of being produced cost-effectively and is to be simple to operate. Parts of the mixing device which are to be disposed of after use of the mixing device are to be of especially simple and cost-effective construction and are to be capable of being produced with only a small quantity of material. Furthermore, the mixing chamber and possible transfer chambers of the dynamic mixer are to be capable of being realized with small volumes, such that only a small quantity of mixing material has to be disposed of or removed when completely replacing or during maintenance of the dynamic mixer.

Furthermore, it would be desirable if the mixing process could be carried out with lower energy demand, such that the material wear and the process heat produced are reduced.

Furthermore, it would be desirable if various mixing ratios of the fed components could be realized with only one device, in which case the mixing ratios are preferably to be adaptable to the requirements of the user in a variable manner.

According to the invention, this object is achieved by the features of the first claim. Further advantageous configurations of the invention follow from the subclaims.

The dynamic mixer has a rotor which is coupled to a drive shaft and is rotatably arranged in a mixing chamber which is provided in a rotor housing and to which at least one first and one second component K1, K2 can be fed. According to the invention, the drive shaft has at least one passage, through which the second component K2 can be introduced into the mixing chamber.

The complexity of the mixing device is considerably reduced due to the feeding of the second component K2 through the passage provided in the drive shaft. No separate connection at the rotor housing is to be provided for the feeding of the second component K2, for which reason said rotor housing can be of exceptionally simple configuration and can be produced cost-effectively. Furthermore, the production, the maintenance and the assembly and dismantling of parts, in particular of the rotor and of the rotor housing, which are to be disposed of after use is simplified.

The rotor, which has a body which is provided with rotor vanes and whose longitudinal axis is preferably oriented coaxially to the axis of the drive shaft, preferably has a coupling cylinder, into which the drive shaft can be inserted, said drive shaft having at least one first closure element, by means of which the drive shaft can be coupled to the rotor in a rotationally fixed manner. The connection between the rotor and the drive shaft is preferably effected by means of a screwed or bayonet connection, such that the rotor is held in place and cannot strike the rotor housing, as a result of which the generation of friction heat is avoided, which friction heat may accelerate the reaction process taking place between the two components K1, K2.

The rotor and the drive shaft can preferably be connected to one another in such a way that the second component K2 can pass only through one or more transfer passages in the rotor to zones in the mixing chamber through which the first component K1 flows. Various advantages thus result. The second component K2 can advantageously be divided into various flows which meet the first component K1 in various zones of the mixing chamber. Uniform mixing can therefore be achieved with few rotor rotations and thus low mechanical energy and therefore reduced process heat, a factor which is especially advantageous in the case of highly viscous substances. Premature curing of parts of the mixed product inside the mixing chamber can therefore be avoided, such that the period of use of the parts to be exchanged after use is significantly prolonged.

Furthermore, due to a preferred configuration of the rotor, the transport of the first component K1 into the mixing chamber and the removal of the mixed product K1×K2 from the mixing chamber can be accelerated. For example, a preferably helically running delivery element is provided on the outer side of the coupling cylinder and/or an output screw is provided on the output-side end of the rotor body.

In a further preferred configuration, the rotor housing provided with an outlet opening has only one inlet opening, into which the drive shaft, possibly already connected to the rotor, and also the first component can be directed. As a result, this inlet opening and therefore the entire rotor housing can be of exceptionally simple configuration and can be produced with minimum cost.

The rotor housing can be formed in a simple manner by a cylinder piece which is provided with an end piece at the front and which can be connected in a tightly closing manner to an opening of a first device body, through which opening the drive shaft and thus the second component are directed and in which a first transfer chamber is formed which is connected to the outlet opening of a first feed device, preferably a first valve, through which the first component K1 can be introduced into the first transfer chamber and further along the drive shaft into the mixing chamber.

The cylinder piece provided on the rotor housing has, for example, an external thread or an external flange, which external thread can be connected to an internal thread of the first transfer chamber or which external flange can be connected by means of a cap nut to a flange connected to the first transfer chamber and provided with an external thread. The rotor and the rotor housing can therefore be assembled and dismantled again in no time at all.

To introduce the second component K2 into the shaft passage, the latter is connected directly or via an input passage to a second transfer chamber which is provided in the first or a second device body and into which the drive shaft projects or through which the drive shaft is passed and which is connected to the outlet opening of a second feed device, preferably a second valve, through which the second component K2 can be introduced into the shaft passage.

The outlet opening of the first and/or of the second valve, which can be actuated mechanically, hydraulically or pneumatically, can preferably be opened or closed by means of a needle which is mounted in an axially displaceable manner inside the valve body by means of an elastic bearing element which tightly closes the valve chamber adjoining the outlet opening and the inlet opening. In a preferred configuration, the elastic bearing element, which is preferably made of plastic or spring steel and which has at least approximately the shape of a plate or a cylinder, is anchored adjacent to the valve chamber preferably in an annular groove, such that the processed components K1; K2 cannot penetrate between the bearing element and the wall of the valve chamber. In contrast to piston-like bearing elements which are guided along the wall of the valve chamber, the operation of the valve cannot be impaired by the processed component in the solution according to the invention. The bearing element has the functions of a diaphragm which tightly closes the valve chamber at the margin and is deflected only in the center in order to axially guide the held needle. The needle has, for example, at least one annular flange which is held by the bearing element or is embedded therein.

Furthermore, the solution according to the invention allows the quantities of the delivered components K1, K2 and the flow velocities to be set with simple measures. To this end, the drive shaft, in the flow region of the two components K1, K2, is provided with appropriate metering elements, for example metering rings, which inhibit the material flow. Furthermore, the volume in the first transfer chamber can be reduced by a metering ring, such that the deceleration time, according to which the first component K1 enters the mixing chamber, can be set. It is described in DE 10112904 A1 that the use of a deceleration chamber may be desirable. Through the use of appropriate metering rings, the transfer chamber can therefore be extended to form a deceleration chamber having a variable volume and a variable deceleration time.

The dynamic mixer according to the invention is therefore outstandingly well suited for mixing components having different volumetric proportions. By appropriate dimensioning of the device parts, in particular of the drive shaft or of the metering elements, the device can be optimized in a simple manner with regard to the desired volumetric ratios.

The components can be introduced into the transfer chambers via feed lines or from locally fitted cartridges. In this case, the dynamic mixer according to the invention, in particular at low inertia of the components used, may also be advantageously realized without mounted valves. The connection of more than two feed lines or valves, which deliver components which are directed inside the drive shaft, for example in a further shaft passage, or outside the drive shaft to the mixing chamber, is of course also possible in a simple manner.

### BRIEF DESCRIPTION OF THE DRAWING

Exemplary embodiments of the invention are explained in more detail below with reference to the drawings. The same elements are provided with the same reference numerals in the various figures. The direction of flow of the media is indicated by arrows.

In the drawing:

FIG. 1 shows a longitudinal section through a dynamic mixer according to the invention which has, at the front, a rotor 2 which is arranged in a housing 1 and is connected to a drive shaft 3 which can be connected to a drive device by means of a coupling piece 91 and which is directed through two transfer chambers 49, 59 which are separated from one another and which are provided in the bodies of two valves 4, 5 which serve to control the feeding of the components K1, K2 to be mixed;

FIG. 2 shows a detail view of FIG. 1, in which the coupling of the rotor 2 and the drive shaft 3 is shown;

FIG. 3 shows a further detail view of FIG. 1, in which the flow of the first and second component K1, K2 from the valves 4, 5 into the mixing chamber 15 is depicted;

FIG. 4 shows, in a sectional illustration, the first valve 4, through which the first component K1 is introduced into the mixing chamber 15;

FIG. 5 shows, in a sectional illustration, the second valve 5, through which the second component K2 is introduced into the mixing chamber 15;

FIG. 6a shows the first valve 4′ in a preferred configuration with a needle 43 which is held by an elastic bearing element 440;

FIG. 6b shows the valve 4′ of FIG. 6a with needle 43 deflected upward and outlet opening 412 opened as a result;

FIG. 7a shows the valve 4″ of FIG. 6a in a further preferred configuration with a needle 43 which is held by a compressible bearing element 440′ supported on one side;

FIG. 7b shows the valve 4″ of FIG. 7a with needle 43 deflected upward and outlet opening 412 opened as a result; and

FIG. 7c shows the valve 4″ of FIG. 7a with a compressible bearing element 440′ supported on both sides.

Only the elements essential for the direct understanding of the invention are shown. Not completely shown, for example, is the drive unit 9 required for the operation of the dynamic mixer.

### Way of Implementing the Invention

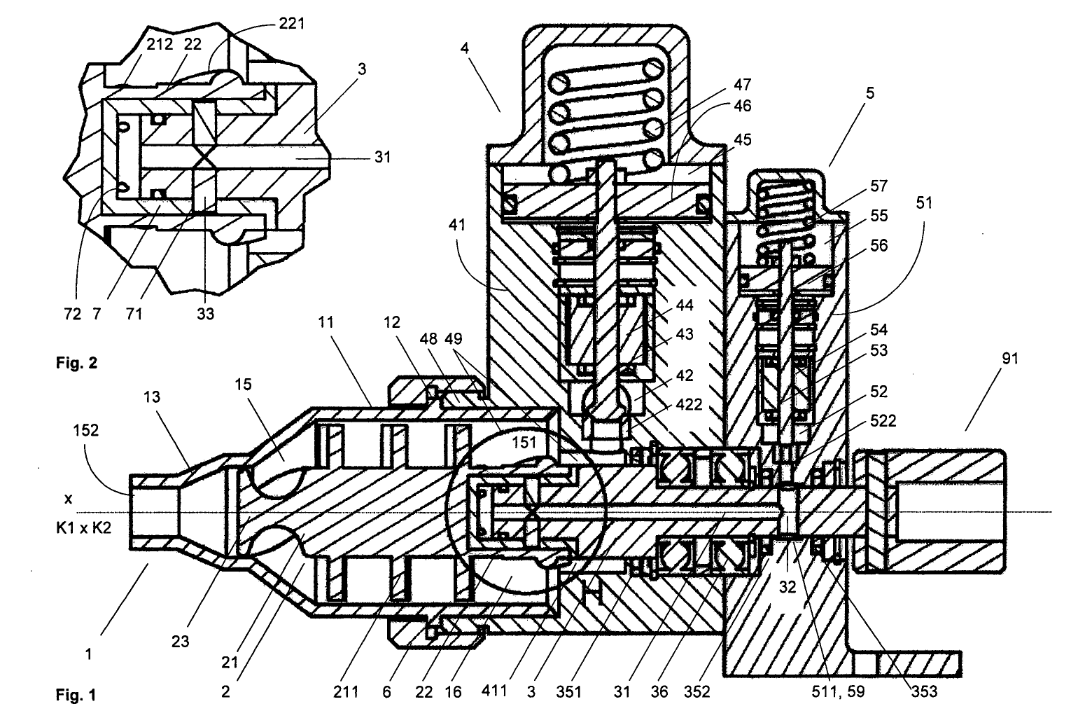

FIG. 1 shows the dynamic mixer according to the invention in a sectional illustration. The dynamic mixer essentially comprises a preferably rotationally symmetrical and thus easy-to-produce rotor housing 1, within which a mixing chamber 15 is provided, in which at least one first and one second component K1, K2 can be mixed. A rotor 2 which has a body 21 provided with vanes 211 is held in the mixing chamber 15 in such a way as to be rotatable by means of a drive shaft 3 which has a shaft passage 31, through which the second component K2 can be introduced into the mixing chamber 15.

In the configuration shown, the rotor housing 1 has an outlet opening 152 serving to deliver the mixed product K1×K2 and only a single inlet opening 151, through which the components K1, K2 and the drive shaft 3 can be introduced into the rotor housing 1. The rear part of the rotor housing 1 is formed by a cylinder piece 11 which is closed off at the front by an end piece 13 provided with the outlet opening 152.

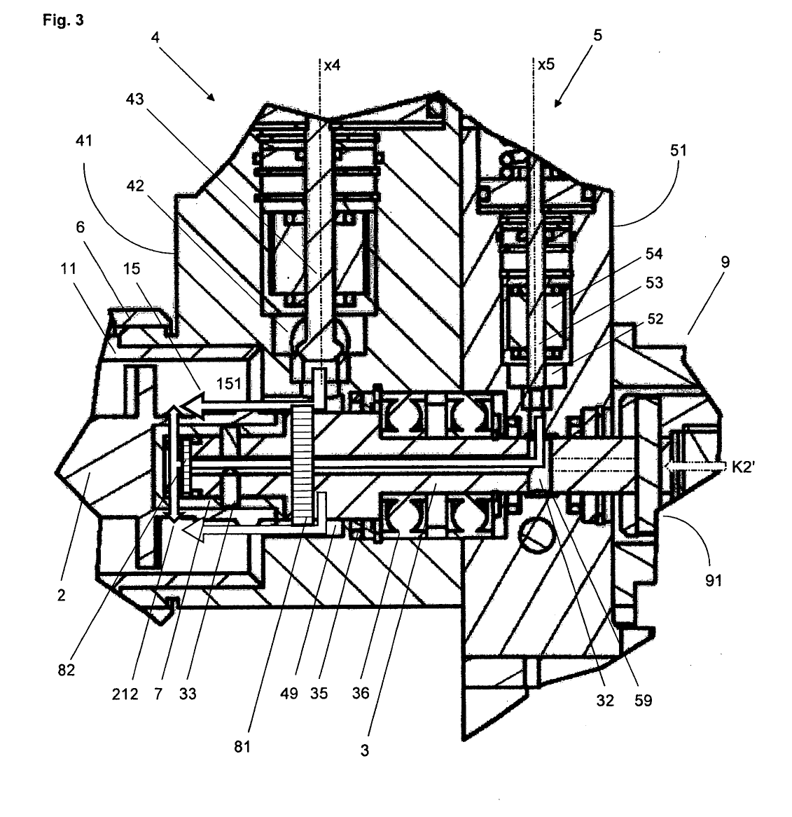

The drive shaft 3 is passed through two device bodies 41, 51 which bear against one another and through which the components K1, K2 to be mixed are introduced into the mixing chamber 15. To this end, the device bodies 41, 51 are provided with valves 4, 5 which have a valve chamber 42; 52 having an inlet opening 421; 521 and an outlet opening 422; 522 which can be closed off or opened by means of a pneumatically or hydraulically actuated valve needle 43; 53. A first and a second transfer chamber 49; 59 are formed between the walls of the openings 411, 511 directed through the two device bodies 41, 51 and the drive shaft 3 provided therein, and the components K1, K2 directed through the outlet openings 422; 522 enter said transfer chambers 49; 59. As shown in FIG. 3, the first component K1 is fed to the mixing chamber 15 through the first transfer chamber 49 along the outer side of the drive shaft 3. The second component K2 is directed from the second transfer chamber 59 into the shaft passage 31 through an input passage 32 provided in the drive shaft 3 and is delivered further to the mixing chamber 15.

On the one side, the first transfer chamber 49 is separated by means of a first seal 351 from bearing elements 36, by means of which the drive shaft 3 is rotatably mounted inside the device bodies 41, 51. On the other side, the first transfer chamber 49 is open toward the mixing chamber 15. The second transfer chamber 59 is closed on both sides by means of second and third seals 352, 353, such that the fed second component K2 can only escape via the input passage 32 and the shaft passage 31 of the drive shaft 3.

The connection between the rotor 2 and the shaft 3 in this preferred configuration is shown enlarged in FIG. 2. On the input side, the rotor 2 has a coupling cylinder 22 which is integrally formed on the rotor body 21 and within which the end piece, provided with the outlet opening of the shaft passage 31, of the drive shaft 3 is anchored. Integrated in the coupling cylinder 22 for this purpose is a preferably metal coupling sleeve 7, which has at least one coupling passage 71, into which a coupling element 33 connected to the drive shaft 3 can be inserted and locked there, thereby resulting in a bayonet catch. The inner wall of the coupling sleeve 7 bears tightly against the drive shaft 3, such that the second component K2 issuing therefrom can pass only through transfer passages 72, 212 in the coupling sleeve 7 and in the coupling cylinder 22 into zones of the mixing chamber 15 through which the first component K1 flows. For the mutual separation and sealing of the individual zones and chambers, sealing elements such as O rings can of course be advantageously put onto the drive shaft 3. One or more transfer passages 212 can be directed in the rotor 2, through which transfer passages 212 the second component K2 is divided into a plurality of flows which are directed to any desired points in the mixing chamber 15. In this preferred configuration, therefore, the mixing of the components K1, K2 is not effected by the rotor 2 alone, but rather is promoted by the specific dividing and feeding of the second component K2. The requisite intermixing of the components K1, K2 can therefore be achieved with just a few rotations of the rotor 2, for which reason less heat is fed to the mixed product K1×K2, which heat would undesirably accelerate reaction processes taking place therein. Furthermore, the robust mounting of the rotor 2 prevents said rotor from being able to slip forward or tilt to the side and rub on the inner wall of the rotor housing 1, as a result of which disturbing friction heat would in turn be fed to the mixed product K1×K2. In the dynamic mixer according to the invention, therefore, a substantial variable which disturbs the mixing process and adversely affects the reaction process of the components K1, K2 is significantly reduced.

Furthermore, it can be seen from FIG. 2 that the coupling cylinder 22 has on its outer side a screw thread which serves as input screw 221, by means of which the first component K1 is delivered into the mixing chamber 15 in an accelerated or decelerated manner. By appropriate selection of the screw thread or of the direction of rotation and of the lead, a chamber 16 having corresponding deceleration or acceleration can be formed in the region of the coupling cylinder 22 without the rotor housing 1 having to be of more complicated design. By means of the output screw 23 integrally formed on the rotor body 21 on the output side, the mixed product K1×K2 produced is delivered toward the outlet opening 152 of the rotor housing 1.

Despite the functions realized, the rotor housing 1 can be of exceptionally simple configuration. Since both components K1, K2 and the drive shaft 3 are introduced only through one opening 151, only the cylinder piece 11 of simple design, which is inserted into the correspondingly adapted opening 411 of the first device body 41, can be provided on the inlet side. To fasten the rotor housing 1, the cylinder piece 11 has an external flange 12 which is pulled by means of a cap nut 6 against a flange 48 integrally formed on the first device body 41 and provided with an external thread. The rotor housing 1 can therefore be assembled and dismantled in no time at all. On account of the separate feeding of the components K1, K2 right into the mixing chamber 15, sticking of coupling and connecting elements 3, 7 and 6, 22, 48, respectively, is avoided. The device parts 1, 2, 3, 4 can therefore be released from one another and cleaned without any problems.

Furthermore, the use of the drive shaft 3 for the transfer of the components K1, K2 which is effected thereon on the inside and the outside allows the material flows to be set in a simple manner. To this end, as shown in FIG. 3, a first metering ring 81 can be put onto the drive shaft 3, said metering ring 81 partly filling the first transfer chamber 49 and reducing its cross section. The flow velocity of the material K1 transported through the first transfer chamber 49 can therefore be increased and the flow quantity, on account of the increased resistance, can be reduced at the same time. The diameter of the outlet opening of the shaft passage 31 can be reduced by a second metering ring 82. The metering rings 81, 82 have, for example, an internal thread, for which a corresponding external thread is arranged on the drive shaft 3. Furthermore, an insert with a bore provided therein which has a reduced diameter can be provided in the shaft passage 31. Furthermore, a lid provided with an outlet opening can be put onto the drive shaft 3.

It can be seen from FIG. 1 that the rotor housing 1, the rotor 2 and the drive shaft 3, which can be coupled to a drive device 9 by means of a coupling element 91, are oriented coaxially to an axis x. Instead of the valve bodies 41, 51 shown in FIG. 1, a single device body may also be provided, to which feed lines for the components K1, K2 can be attached. The dynamic mixer can therefore be of exceptionally narrow construction and can therefore also be operated in a simple manner.

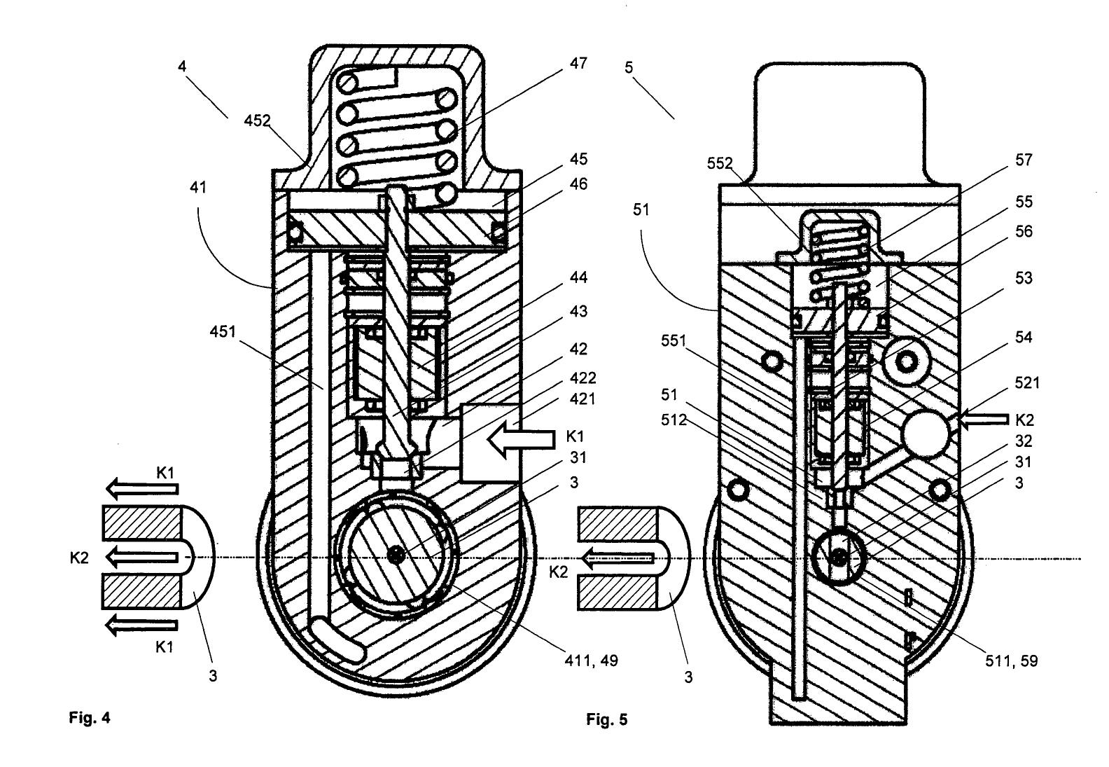

As shown in FIGS. 1, 4 and 5, the valves 4, 5 may be advantageously integrated in the dynamic mixer. A separate valve 4, 5 having a separate valve body 41, 51 which has a continuous opening or bore 411, 511 for passing the drive shaft 3 through is preferably used for each component K1; K2 fed. As mentioned above, the valve bodies have a valve chamber 42; 52 with an inlet opening 421; 521 and an outlet opening 422, 522, which can be closed or opened by means of a pneumatically or hydraulically actuated valve needle 43; 53 in order to control the inflow of the first and second components K1, K2 into the associated transfer chambers 49, 59. The valve needle 43; 53 is mounted in an axially displaceable manner by means of a bearing element 44; 54 and is held by a piston 46; 56 which is displaceably mounted in a pressure chamber 45; 55, to which a pneumatic or hydraulic medium can be fed via a pressure passage 451; 551. The pressure chamber 45; 55 is closed off at the top by means of a lid 452; 552, in which a spring 47; 57 is held which constantly presses the piston 46; 56 and thus the valve needle 43; 53 downward, such that the outlet opening 422; 522 is always closed when no medium is forced into the pressure chamber 45; 55.

The valve needle 43; 53, which is in contact on the one side with the fed component K1; K2, is therefore axially displaced inside the bearing element 44; 54, or the valve needle 43; 53 is displaced together with the bearing element 44; 54. In the process, there is the risk of the relevant component K1; K2 being able to penetrate into the region between the bearing element 44; 54 and the valve needle 43; 53 or into the region between the bearing element 44; 54 and the outer wall, as a result of which the bearing function is impaired.

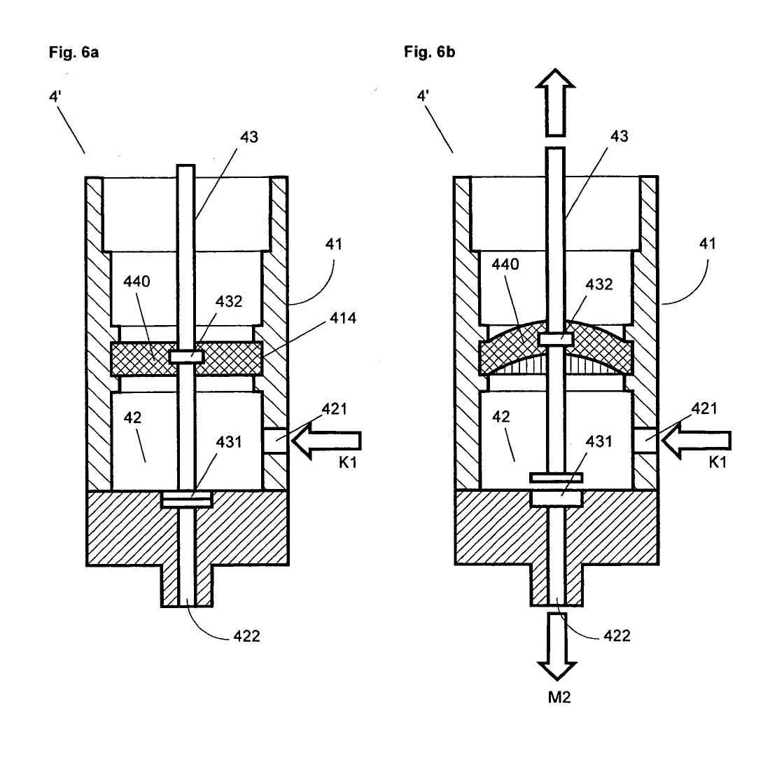

This problem is solved in the valve 4′ shown in FIGS. 6a and 6b by an elastic bearing element 440 being used instead of an inelastic bearing element 44, said elastic bearing element 440 being held at the periphery, for example, in an annular groove 414 adjoining the valve chamber 42 and being connected centrally to the valve needle 43. As shown in the figures, the valve needle 43 may be surrounded by an annular flange 432 which is embedded in the bearing element 440, which is made of plastic for example. The bearing element 440 may also adjoin an annular flange 432 on both sides. During the operation of the valve 4′, the bearing element 440 held at the periphery is deflected, as shown in FIG. 6b, like a diaphragm by the valve needle 43, such that the closure piece 431 provided thereon clears the outlet opening 422 of the valve chamber 42. The valve needle 43 may in turn be actuated mechanically, pneumatically or hydraulically.

It is therefore advantageous in this device that the bearing element 440 reliably seals off the valve chamber 42, such that maintenance-free operation of the valve 4′ is ensured. Furthermore, it is advantageous that the restoring force required for the operation of the valve 4′ is produced entirely or at least partly by the bearing element 440, such that a restoring spring 47 may possibly be dispensed with.

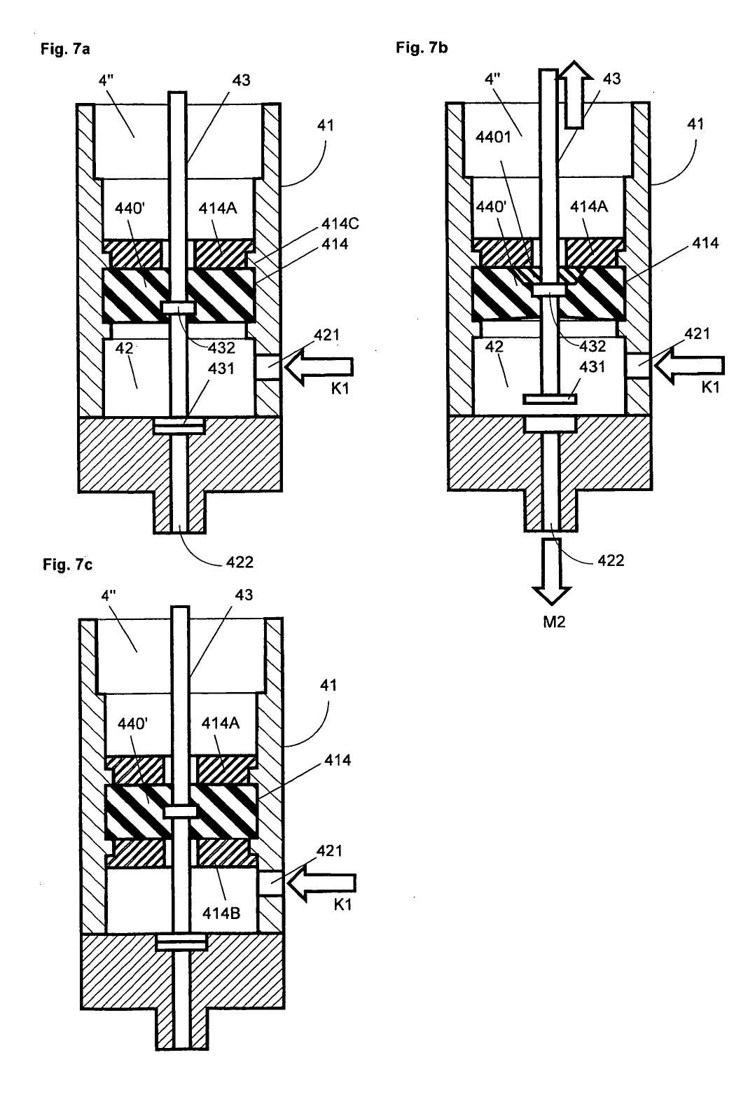

FIG. 7a shows the first valve 4″ of FIG. 6a in a further preferred configuration. Instead of the elastic bearing element 440 in the configuration there, a compressible bearing element 440′ is provided which holds the needle 43 and mounts it in a vertically displaceable manner. The bearing element 440′ is made of a flexible, compressible material, for example a very soft elastomer.

It is especially advantageous in this configuration that the needle 43 is also precisely guided in this solution, but no deflection is effected, but rather only a local compression of the bearing element 440′ and therefore no or only a minimum material displacement during the closing of the valve 4″ or during the return of the needle 43. Provided the annular flange 432 is held in the interior of the compressible bearing element 440′, only the compression, shown in FIG. 7b, of an internal material segment is effected, during which virtually no external deformation of the bearing element 440′ occurs. Disturbing pressure changes during the opening and closing of the valve 4″, which lead to an uncontrollable application pattern, are therefore avoided with the aid of the compressible bearing element 440′.

So that the bearing element 440′ is compressed but not deflected, an end plate 414A is provided on its top side, this end plate 414A having an opening, which serves to pass the needle 43 through, and, in this preferred configuration, an external thread, by means of which it is screwed to an internal flange 414C which defines the annular groove 414 on one side.

FIG. 7b shows the valve 4″ of FIG. 7a with needle 43 deflected upward and outlet opening 422 opened as a result. Furthermore, it is schematically shown that material of the bearing element 440′ is locally compressed between the annular flange 432 and the end plate 414A in this position of the needle 43 without significant external deformation of the bearing element 440′.

In this configuration, too, the bearing element 440′ reliably seals off the valve chamber 42, such that maintenance-free operation of the valve 4″ is ensured.

FIG. 7c shows the valve 4″ of FIG. 7a with the compressed bearing element 440′, which is supported on both sides by end plates 414A, 414B. In this configuration, external deformations and deflections of the bearing element 440′ are prevented in both directions, such that the valve functions are further optimized.

The dynamic mixer according to the invention has been shown and described in preferred configurations. Further configurations can easily be realized by a person skilled in the art with the aid of the principles according to the invention. In particular, the device body 41, 51, in which the drive shaft 3 is mounted and which is connected at the front to the rotor housing 1, can be configured in various ways and can thus be adapted to the requirements of the respective user. The device body 41, 51 may consist of one or more elements connected to one another. Valves may be provided on or in the device body 41, 51 or also on an external pressure generator which is connected to the dynamic mixer via feed lines. The connection between the rotor housing 1 and the device body 41, 51 and the connection between the rotor 2 and the drive shaft 3 may also be effected in another way. Furthermore, a plurality of shaft passages 31 may also be provided in the drive shaft 3. Components K2 having smaller volumetric proportions are preferably delivered through the drive shaft 3. However, the volumetric proportions can be freely selected by the corresponding device parameters or metering elements being correspondingly selected or set.

Furthermore, the simple construction allows the mixing chamber 15, the deceleration chamber 16, if provided, and the transfer chambers 49, 59 to be realized with minimum volumes, such that only a small quantity of mixing material has to be disposed of or removed when completely replacing or during maintenance of the dynamic mixer.

The connection between the drive shaft 3 and the rotor 2 has been shown in a preferred configuration. The use of a gear unit, for example an angular gear unit, is of course also possible.

### List of Designations

1 Rotor housing
11 Cylinder piece
12 External flange
13 End piece
15 Mixing chamber
151 Inlet opening
152 Outlet opening
16 Deceleration chamber in the rotor housing

### 2 Rotor

21 Rotor body
211 Rotor vanes
22 Coupling cylinder
221 Input screw on the coupling cylinder 21
23 Output screw
3 Drive shaft
31 Shaft passage
32 Input passage
33 Closure elements, anchored in the drive shaft 3
351 First seal at the drive shaft 3
352 Second seal at the drive shaft 3
353 Third seal at the drive shaft 3
36 Bearing unit
4, 4′, 4″ First valve
41 Valve body
411 Opening for passing the drive shaft 3 through
414 Annular groove for accommodating the elastic bearing element 440
414A Top cover plate
414B Bottom cover plate
42 Valve chamber
421 Inlet opening to the valve chamber 42
422 Outlet opening to the valve chamber 42
43 Closure needle
431 Closure piece
432 Annular flange
44 Inelastic bearing element
440 Elastic bearing element
440′ Compressible bearing element
45 Pressure chamber
451 Pressure passage

### 452 Cover

### 46 Piston

### 47 Spring

### 48 Flange

49 First transfer chamber
5 Second valve
51 Valve body
511 Opening for passing the drive shaft 3 through
52 Valve chamber
521 Inlet opening to the valve chamber 52
522 Outlet opening to the valve chamber 52
53 Closure needle
54 Inelastic bearing element
55 Pressure chamber
551 Pressure passage

### 552 Cover

### 56 Piston

### 57 Spring

59 Second transfer chamber

### 6 Cap nut

7 Coupling sleeve
71 Coupling passage
72 Transfer passages in the coupling sleeve 7
81 First metering ring
82 Second metering ring
9 Drive device
91 Coupling element

1. A dynamic mixer having a rotor which is coupled to a drive shaft and is rotatably arranged in a mixing chamber which is provided in a rotor housing and to which at least one first and one second component can be fed, wherein the drive shafts has at least one shaft passage, through which the second component can be introduced into the mixing chamber.

2. The device as claimed in claim 1, wherein the rotor has a body which is provided with rotor vanes and having a longitudinal axis, and a coupling cylinder, into which the drive shaft can be inserted, said drive shaft having at least one first closure element, by which the drive shaft and the rotor can be coupled in a rotationally fixed manner.

3. The device as claimed in claim 2, wherein the rotor and the drive shaft can be coupled to one another by a screwed connection or a bayonet connection in such a way that the second component can only pass through the rotor into at least one zone of the mixing chamber through which the first component flows.

4. The device as claimed in claim 1, wherein the rotor has one or more transfer passages, through which the second component fed through the shaft passage can pass through the coupling cylinder and/or through the body of the rotor into the zones of the mixing chamber through which the first component flows.

5. The device as claimed in claim 2, wherein the coupling cylinder has, on its outer side, a helically running delivery element, and/or in that the rotor body has an output screw on the output side.

6. The device as claimed in claim 2, wherein the rotor housing is rotationally symmetrically configured and has, on one side, an end piece having an outlet opening for the mixed components and, on the other side, a cylinder piece having an inlet opening for the feeding of the two components, into which inlet opening the drive shaft, possibly already connected to the rotor, can be inserted coaxially to the cylinder piece.

7. The device as claimed in claim 6, wherein the cylinder piece can be connected in a tightly closing manner to a first transfer chamber which is provided in a first device body and through which the drive shaft is directed and which is connected to the outlet opening of a first feed device, through which the first component can be introduced into the first transfer chamber and further along the drive shaft into the mixing chamber.

8. The device as claimed in claim 6, wherein the shaft passage is connected directly or via an input passage to a second transfer chamber which is provided in the first or a second device body and into which the drive shaft projects or through which the drive shaft is passed and which is connected to the outlet opening of a second feed device, through which the second component can be introduced into the shaft passage.

9. The device as claimed in claim 2, wherein the cylinder piece has an external thread or an external flange, which external thread can be connected to an internal thread of the first transfer chamber or which external flange can be connected by means of a cap nut to a flange connected to the first transfer chamber and provided with an external thread.

10. The device as claimed in claim 7, wherein the outlet opening of the first and/or of the second feed device can be actuated mechanically, hydraulically or pneumatically, and can be opened or closed by means of a needle which is displaceably mounted inside a body of the feed device by an elastic and/or compressible bearing element which tightly closes a chamber adjoining the outlet opening and the inlet opening.

11. The device as claimed in claim 10, wherein the elastic bearing element is made of plastic or spring steel, or the compressible bearing element made of a soft elastomer, said bearing elements having at least approximately the shape of a plate or a cylinder, and
a) is anchored adjacent to the feed device chamber in an annular groove; and/or
b) encloses an annular flange surrounding the needle; and/or
c) completely or at least partly produces the restoring force required for the operation of the feed device.

12. The device as claimed in claim 10 wherein the compressible bearing element is supported by cover plates on the top side or on the top side and the underside.

13. The device as claimed in claim 1, wherein the drive shaft is provided with at least one metering ring which is arranged inside the first transfer passage or at an inlet or outlet opening of the shaft passage.

14. The device as claimed in claim 1, wherein the drive shaft is coupled to a drive device.

15. (canceled)

16. The device as claimed in claim 2, wherein the longitudinal axis is oriented coaxially to the axis of the drive shaft.

17. The device as claimed in claim 7, wherein the first feed device is a first valve.

18. The device as claimed in claim 8, wherein the second feed device is a second valve.
